(19) United States
(12) Patent Application Publication
(10) Pub. No.: US 2014/0351936 A1
(43) Pub. Date: Nov. 27, 2014

(54) FREQUENCY-VARIABLE ANTI-VIRUS TECHNOLOGY

(71) Applicant: Xiaojun Hao, Beijing (CN)

(72) Inventor: Xiaojun Hao, Beijing (CN)

(73) Assignee: BEIJING RISING INFORMATION TECHNOLOGY CO., LTD., Beijing (CN)

(21) Appl. No.: 14/366,693

(22) PCT Filed: Dec. 19, 2011
(86) PCT No.: PCT/CN2011/084212

§ 371 Date: Jun. 19, 2014

(51) Int. Cl. G06F 21/56

(52) U.S. Cl. CPC G06F 21/561; G06F 21/566
USPC 726/24

(57) ABSTRACT

A frequency-variable anti-virus technology relates to a method and apparatus for dynamically adjusting an amount of system resources occupied by security protection software running on a user device. The method comprises: collecting, by the security protection software, state information associated with the user device; calculating the expected operating intensity of the security protection software based on the state information; and operating the security protection software based on the calculated expected operating intensity, so as to adjust the amount of system resources occupied by the security protection software. The apparatus may comprise means for performing the abovementioned steps, respectively. The method and apparatus may be used to dynamically adjust an operating policy of the security protection software, so as to more rationally allocate system resources among the software of the user device, thus improving the usage efficiency of the system resources and improving the usage experience of the user.

### TECHNICAL FIELD

This application relates to the field of security protection for a user device, and more specifically, to the technology for dynamically adjusting an operating policy of security protection software on the user device.

### BACKGROUND

With the rapid development of the information industry, a variety of devices serving users, such as servers, desktop computers, notebook computers, netbooks, cell phones, PDAs, electronic books and so on, are widely used. A large amount of various software, which for example may include operating systems, office software such as Microsoft Office, various entertainment software, security protection software such as software for scanning/killing viruses, file transport software and the like, may be installed on these devices so as to satisfy a variety of user needs. Among these software, security protection software is becoming more and more important.

Security protection software is mainly used to scan/kill computer viruses. A computer virus is data disrupting the functions of a user device which is programmed or inserted into computer program. It will influence the normal use of the user device and is able to self-replicate, and it usually appears in the form of a set of computer instructions or program codes. A computer virus has characteristics of destructiveness, replicability and infectivity and it damages the security of the user device greatly. Specifically, with the rapid popularization of the network, the virus spreading speed becomes more and more rapid and the spreading scope becomes wider and wider. Therefore, security protection software needs to run all the time when the user device starts up, so as to protect the security of the user device. In the prior art, security protection software usually traverses all files in a system, and compares the files with the existing virus feature codes. If a file is found to be matched, then it is shown that the file contains the computer virus, and thus the security protection software will perform a clear or deletion operation on the file depending on the situations. However, with the development of storage technology, the user device contains more and more files, and thus corresponding scanning/killing time becomes longer and longer. Moreover, since the techniques, such as encryption, compression, self-replication and so on, are widely employed by computer viruses, data calculation of a large scale is usually needed for the detection and processing of computer viruses. The above situations cause a large amount of system resources to be consumed during security protection software is running on the user device.

In normal cases, in addition to security protection software, one or more other software, such as office software, are also running on the user device at the same time. Thus, there is a competition for various system resources of the user device, such as processor(s), memory, and bandwidth and so on, between the security protection software and these other software. Since the system resources of the user device are always limited, if no intervention is made for such competition, then a negative influence will be made to the user's normal usage, and thus the user's experience will be influenced. For example, in the case where a user now wants to use text input software to input texts, the text input by the user may not be smoothly accomplished if security protection software has occupied a large amount of system resources. Therefore, in this field, a technology capable of dynamically adjusting an operating policy of the security protection software is expected, so as to more rationally allocate system resources among various software of the user device, thereby improving the usage efficiency of system resources and improving the usage experience of users.

### SUMMARY

The main object of this invention is to provide a method and apparatus capable of dynamically adjusting an amount of system resources occupied by security protection software based on state information associated with a user device.

One aspect of this invention may relate to a method for dynamically adjusting an amount of system resources occupied by security protection software running on a user device, comprising: collecting, by the security protection software, state information associated with the user device; calculating an expected operating intensity of the security protection software based on the state information; and operating the security protection software based on the calculated expected operating intensity, so as to adjust the amount of system resources occupied by the security protection software.

Preferably, the state information includes timing, type, number of times and/or frequency of an operation performed by a user of the user device; and/or software environment information and/or hardware environment information of the user device.

Preferably, the operation performed by the user is directly obtained from a driver layer, so as to avoid a collision with other software running on the user device.

Preferably, the software environment information and/or hardware environment information includes at least one of a size of memory of the user device, a usage condition of the memory of the user device, a speed of a processor of the user device, a usage condition of the processor of the user device, information of processes currently running on the user device, a current network connection condition of the user device, a current bandwidth usage condition of the user device, a usage condition of an input device of the user device.

Preferably, the above method further comprises: reducing an amount of various network request data associated with the security protection software if the network connection condition belongs to per-flow accounting.

Preferably, the state information includes state information at present and/or in a past period of time.

Preferably, the operating intensity includes an operating frequency of a thread of the security protection software.

Preferably, the operating intensity does not have a limited number of fixed levels assigned thereto, such that the operating intensity is adjusted without being limited to the fixed levels.

Preferably, a gradual change policy is used if the operating intensity of the security protection software is to be increased, and a sudden change policy is used if the operating intensity of the security protection software is to be decreased.

Another aspect of this invention may relate to an apparatus for dynamically adjusting an amount of system resources occupied by security protection software running on a user device, comprising: means for causing the security protection software to collect state information associated with the user device; means for calculating an expected operating intensity of the security protection software based on the state information; and means for operating the security protection software based on the calculated expected operating intensity, so as to adjust the amount of system resources occupied by the security protection software.

Preferably, the apparatus further comprises: means for reducing an amount of various network request data associated with the security protection software if the network connection condition belongs to per-flow accounting.

Through employing the above method and apparatus of this invention, the system resources may be allocated more rationally among various software of the user device, thereby improving the usage efficiency of the system resources and improving the user's usage experience.

### DESCRIPTION OF DRAWINGS

This invention is described in details with reference to the drawings. It should be understood that the drawings and the corresponding description should be construed as illustrative rather than limiting, in which:

FIG. 1 shows a user device according to one embodiment of this invention;

FIG. 2 shows a method for dynamically adjusting an operating policy of security protection software according to one embodiment of this invention;

FIG. 3 shows an apparatus for dynamically adjusting an operating policy of security protection software according to one embodiment of this invention;

FIG. 4 shows a method for dynamically adjusting an operating policy of security protection software according to another embodiment of this invention;

FIG. 5 shows an apparatus for dynamically adjusting an operating policy of security protection software according to another embodiment of this invention.

### DETAILED DESCRIPTION OF ILLUSTRATIVE EXAMPLES

This invention will be described below in more details with the detailed description. It should be noted that the detailed description is only to make this invention more comprehensible rather than to limit this invention.

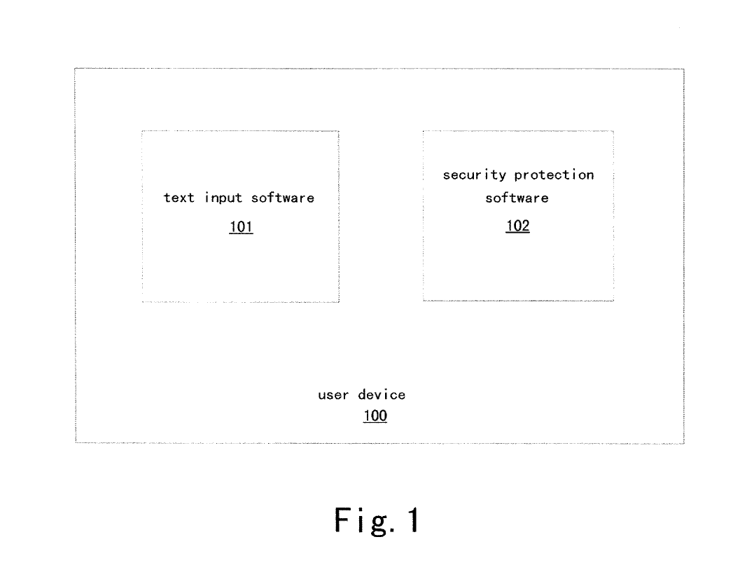

FIG. 1 shows a user device 100 according to one embodiment of this invention. Security protection software 102 is running on the user device 100, meanwhile one or more other software may also be running on the user device 100 at the same time. FIG. 1 shows one text input software 101 only, by way of illustration. Since the text input software 101 and the security protection software 102 have different characteristics and are used to satisfy different user needs respectively, the operating policy of the security protection software 102 is enabled to be dynamically adjusted, so as to more rationally allocate system resources between the text input software 101 and the security protection software 102, thereby improving the usage efficiency of the system resources and improving the user's usage experience.

For example, in the embodiment shown in FIG. 1, when a user operates the text input software 101 on the user device 100 to input texts, it is usually required for the text input software 101 to be able to rapidly respond (for example, to rapidly display the contents input just now by the user on the screen of the user device 100). However, security protection software in the prior art always uses a fixed speed to process files, which may cause the user to feel that the processing speed of the user device is very slow and the text input can not be accomplished smoothly when the user is inputting texts, because the security protection software currently running on the user device has occupied a large amount of system resources. Therefore, in the prior art, the user may have to spend more time to accomplish the text input, or need to manually pause or turn off the security protection software, which however will put the user device into the risk of virus infection. Moreover, in some environments requiring high level of security, an ordinary user is not allowed to pause or turn off the security protection software. On the other hand, when the user does not use the device or performs few operations on the device, the available system resources of the user device can not be fully utilized since the security protection software performs the processing at a fixed speed likewise.

According to this invention, the security protection software 102 may calculate its expected operating intensity based on state information associated with the user device, and then run based on the expected operating intensity, thus the amount of system resources occupied by it can be adjusted. For example, when the security protection software 102 in FIG. 1 detects that the user is inputting texts with a keyboard and/or detects that it has occupied excessive system resources, it may decrease its own operating intensity (for example, decrease the frequency for virus scanning), so as to reduce the amount of system resources occupied by it, such that the user's text input operation is not influenced. In this way, for the user, he is able to accomplish the text input without manually making any other adjustment or setting operations. On the other hand, when the security protection software 102 detects that the user does not perform any operation on the user device any more, it may increase its operating intensity (for example, increase the frequency for virus scanning). Therefore, for a longer period of time, the security protection software 102 may still ensure the security of the user device perfectly, since it increases the operating intensity when the user device is idle.

Although one text input software 101 is described as an example in FIG. 1, it can be appreciated by those skilled in the art that this invention may also be applied with one or more software of other types.

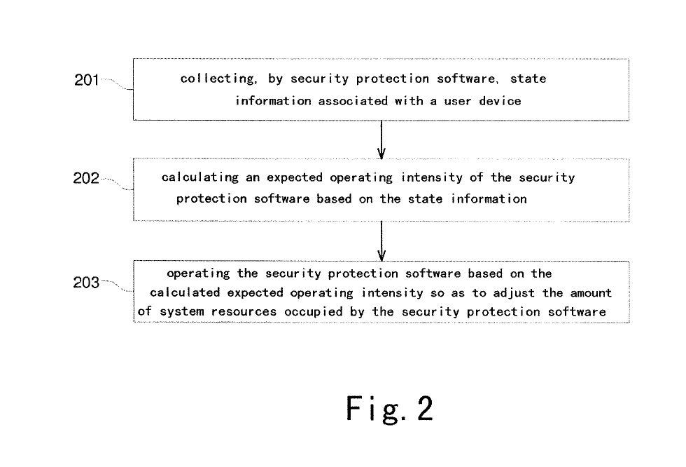

FIG. 2 shows a method for dynamically adjusting an operating policy of security protection software according to one embodiment of this invention.

According to this method, at step 201, the security protection software collects state information associated with a user device. The state information may be state information of the user device at present and/or in a past period of time. The state information, for example, may include software and/or hardware environment information of the user device, which is for example, but not limited to: a size of memory of the user device, a usage condition of the memory of the user device, a speed of a processor of the user device, a usage condition of the processor of the user device, information of processes currently running on the user device, a current network connection condition of the user device, a current bandwidth usage condition of the user device, a usage condition of an input device of the user device. The state information may further include timing, type, number of times and/or frequency and the like of an operation performed by the user. The operation performed by the user may be input with an input device such as a keyboard, a mouse, a gamepad, or the like.

At step 202, an expected operating intensity of the security protection software is calculated based the state information. The operating intensity may be an operating frequency of a thread of the security protection software, such as the frequency of scanning by a thread associated with a scanning service. In addition, the operating intensity may not have a limited number of fixed levels artificially assigned thereto, such that the operating intensity can be adjusted without being limited to the fixed levels, that is, the operating intensity can be adjusted continuously rather than discretely.

The security protection software may calculate its own different expected operating intensities based on different state information. For example, if the state information shows that the hardware configuration of the user device is lower, or shows that the processor, memory or bandwidth of the user device is less available, then the security protection software may generally be expected to run at a lower operating intensity; and if the state information shows that the user performs more operations on the user device currently or recently, then the security protection software may generally be expected to run at a lower operating intensity; while in the cases contrary to the above situations, the security protection software may generally be expected to run at a higher operating intensity.

It should be understood that the above situations are just a few simple examples, and the security protection software implementing the method of this invention may systematically take various state information into account to calculate its expected operating intensity. For example, when the user device is performing large-scale calculation, such as video processing, rendering, large-scale file operations, high definition video playing, compiling and so on, there is a need to use many system resources even if the user operations are few. At that time, the actual usage condition of the user device may be reflected otherwise by the collected process-related data, memory-related data, processor-related data or bandwidth-related data. Then, the operating intensity of the security protection software may be accordingly decreased based on such data, avoiding the improper increasing of the operating intensity merely based on certain state information (for example, the fact that the user merely performs few operations).

It should be understood that, depending on the actual specific situations, the expected operating intensity of the security protection software may be obtained based on the state information associated with the user device with different algorithms or policies, without being limited to the above specific examples.

At step 203, the security protection software operates based on the calculated expected operating intensity, and thus the amount of system resources occupied by the security protection software is adjusted. For example, the security protection software may operate based on the calculated operating intensity represented by a frequency variation parameter, so as to intelligently decrease or increase the scanning frequency of a work thread associated with a scanning service, thereby adjusting its own occupied resource amount. Preferably, if the operating intensity of the security protection software is to be increased, a gradual change policy is used to cause the operating intensity of the security protection software to gradually reach the expected operating intensity; whereas if the operating intensity of the security protection software is to be decreased, a sudden change policy is used to cause the operating intensity of the security protection software to immediately reach the expected operating intensity, so as not to influence the user's other operations.

As such, the operating policy of the security protection software may be dynamically adjusted based on the state information associated with the user device. Thus in some cases, the operating intensity can be decreased so as to try to reduce the influence to the user's other normal operations. In other cases, the operating intensity can be increased so as to increase the utilization rate of the system resources of the user device. Therefore, the usage efficiency of the system resources of the user device is improved in overall, and users can get a better usage experience.

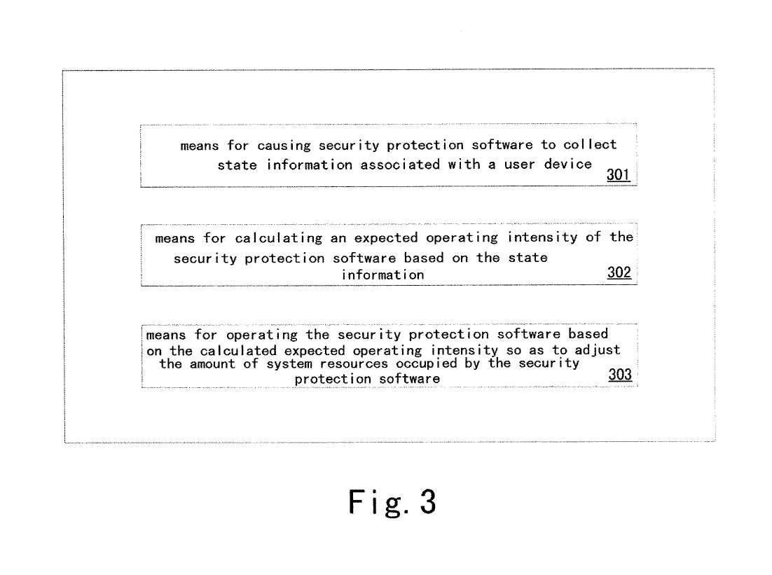

FIG. 3 shows an apparatus for dynamically adjusting an operating policy of security protection software, comprising: means for causing the security protection software to collect state information associated with a user device, 301; means for calculating an expected operating intensity of the security protection software based on the state information, 302; and means for operating the security protection software based on the calculated expected operating intensity so as to adjust an amount of system resources occupied by the security protection software, 303.

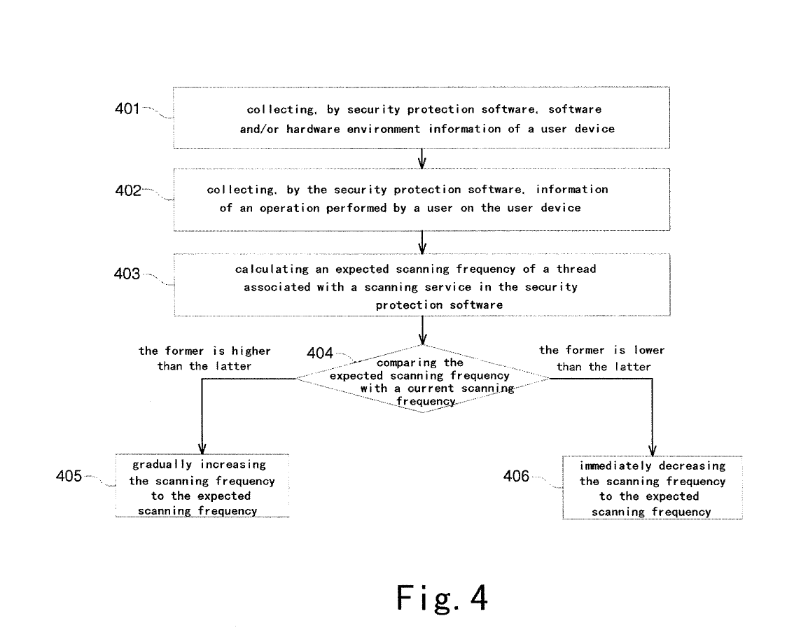

FIG. 4 shows a method for dynamically adjusting an operating policy of security protection software according to another embodiment of this invention.

According to this method, at step 401, the security protection software collects software and/or hardware environment information of a user device at present and/or in a past period of time. At step 402, the security protection software collects information of operations performed by a user on the user device at present or in a past period of time. There is no strict precedence relationship between the above two steps, and these two steps may be performed in a different order or may be performed concurrently. In other embodiments, only one of steps 401 and 402 may be performed.

At step 403, an expected scanning frequency of a thread associated with a scanning service in the security protection software is calculated based on the information collected by the security protection software in step 401 and/or step 402.

At step 404, the expected scanning frequency is compared with a current scanning frequency of the scanning thread. If the expected scanning frequency is higher than the current scanning frequency, at step 405, the scanning frequency of the scanning thread of the security protection software is gradually increased to the expected scanning frequency. If the expected scanning frequency is lower than the current scanning frequency, at step 406, the scanning frequency of the scanning thread of the security protection software is immediately decreased to the expected scanning frequency. If the expected scanning frequency is equal to the current scanning frequency, then the operation for changing the frequency is not performed. Thus, the scanning thread in the security protection software may operate based on the calculated expected scanning frequency, such that the amount of system resources occupied by the security protection software can be adjusted.

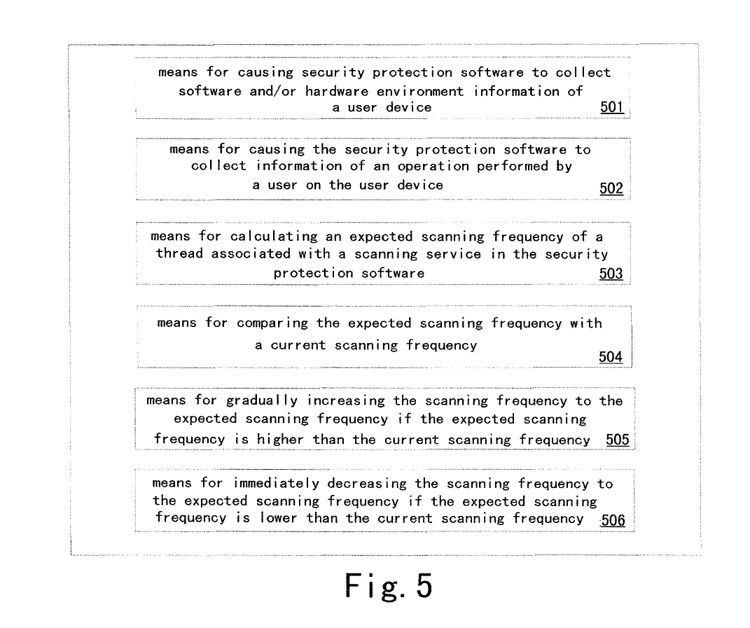

FIG. 5 shows an apparatus for dynamically adjusting an operating policy of security protection software according to another embodiment of this invention, comprising: means for causing the security protection software to collect software and/or hardware environment information of a user device, 501; means for causing the security protection software to collect information of operations performed by a user on the user device, 502; means for calculating an expected scanning frequency of a thread associated with a scanning service in the security protection software based on the collected information, 503; means for comparing the expected scanning frequency with a current scanning frequency, 504; means for gradually increasing the scanning frequency to the expected scanning frequency if the expected scanning frequency is higher than the current scanning frequency, 505; and means for immediately decreasing the scanning frequency to the expected scanning frequency if the expected scanning frequency is lower than the current scanning frequency, 506. Furthermore, in other embodiments, the above apparatus may not comprise one of the means 501 or means 502, and it is not necessary to comprise both of them at the same time.

The following describes in more details how to detect timing, type, number of times and/or frequency and the like of a user operation. This description is merely for the purpose of illustration and some other detecting manners are feasible.

This invention may not employ a conventional manner for listening to messages by hooking to obtain input statistical data, rather it directly obtains operations performed by the user through a driver layer, which may improve the reliability and stability of functions of a product and may avoid colliding with other software.

In addition, a user device may have a plurality of different input devices and some input devices may have various different input types, such as left-click, right-click, left-double-click, move, drag and the like of a mouse. However, these different types of inputs do not have the same meaning or result in the same influence. For example, in normal cases, compared with mouse moving, mouse click or keyboard input is more meaningful or will result in a greater influence. Thus, it is meaningful to distinguish different input types of these different input devices and make respectively-different statistics for these different types of inputs, which can provide more detailed state information associated with the user operations. Usually, the differences among the actual meanings or influences of different types of inputs may be concluded based on the analyses of the user's operation behaviors and operation habits. In order to distinguish the actual meanings or influences of different types of inputs, different weights may be assigned to various different types of inputs. For example, “ftype(InputType)” may be used to calculate a valid statistical weight value of a certain input type, wherein “InputType” represents an input type, and “ftype” is a weighting function which may be an empirical equation obtained based on the analyses of the user's operation behaviors and habits. The above way refines the state information associated with the user operations to a certain extent, and thus further improves the intelligence degree of the security protection software.

Preferably, when the expected operating intensity of the security protection software is calculated based on the statistical data associated with the user operations, the jitter that it may cause, such as the frequent and drastic change of the operating intensity of the security protection software, should be avoided. For example, in the case where the time distribution of the user operations is not uniform, if the operating intensity is changed merely based on the statistical information of the user operations at present or in a very recent period of time, then a jitter may occur, which will cause an undesirable influence to the user's experience. Therefore, this invention may introduce a smoothing mechanism for user operations to avoid jitters. For example, this mechanism may take the user operations in a longer period of time into account, and different suitable weights are assigned to respective operations depending on how far these operations are from the current time. In addition, the jitter may also be avoided in a certain degree by using the gradual change policy if the operating intensity is to be increased.

It should be noted that when the user input data is collected, only statistical information associated with the user input is collected, while any actual content input by the user will not be collected. Moreover, this statistical information is only used for the user's own device, which will not result in a leakage of the user information.

The illustrative implementations of this invention are described above with reference to the drawings. However, it is obvious for those skilled in the art that various other modifications and variations may be easily obtained from the above illustrative implementations, depending on different specific situations. All these modifications and variations should be considered as falling into the substantive scope of this invention.

1. A method for dynamically adjusting an amount of system resources occupied by security protection software running on a user device, the method comprises:
collecting, by the security protection software, state information associated with the user device;
calculating an expected operating intensity of the security protection software based on the state information; and
operating the security protection software based on the calculated expected operating intensity, so as to adjust the amount of system resources occupied by the security protection software.

2. The method according to claim 1, wherein the state information includes:
timing, type, number of times and/or frequency of an operation performed by a user of the user device; and/or
software environment information and/or hardware environment information of the user device.

3. The method according to claim 2, wherein the operation performed by the user is directly obtained from a driver layer, so as to avoid a collision with other software running on the user device.

4. The method according to claim 2, wherein the software environment information and/or hardware environment information includes at least one of:
a size of memory of the user device, a usage condition of the memory of the user device, a speed of a processor of the user device, a usage condition of the processor of the user device, information of processes currently running on the user device, a current network connection condition of the user device, a current bandwidth usage condition of the user device, and a usage condition of an input device of the user device.

5. The method according to claim 4, further comprises:
reducing an amount of various network request data associated with the security protection software if the network connection condition belongs to per-flow accounting.

6. The method according to claim 1, wherein the state information includes state information at present and/or in a past period of time.

7. The method according to claim 1, wherein the operating intensity includes an operating frequency of a thread of the security protection software.

8. The method according to claim 1, wherein the operating intensity does not have a limited number of fixed levels assigned thereto, such that the operating intensity is adjusted without being limited to the fixed levels.

9. The method according to claim 1, wherein a gradual change policy is used if the operating intensity of the security protection software is to be increased, and a sudden change policy is used if the operating intensity of the security protection software is to be decreased.

10. The method according to claim 5, wherein
the operation performed by the user is directly obtained from a driver layer, so as to avoid a collision with other software running on the user device;
the state information includes state information at present and/or in a past period of time;
the operating intensity includes an operating frequency of a thread of the security protection software;
the operating intensity does not have a limited number of fixed levels assigned thereto, such that the operating intensity is adjusted without being limited to the fixed levels; and
a gradual change policy is used if the operating intensity of the security protection software is to be increased, and a sudden change policy is used if the operating intensity of the security protection software is to be decreased.

11. An apparatus for dynamically adjusting an amount of system resources occupied by security protection software running on a user device, the apparatus comprises:
means for causing the security protection software to collect state information associated with the user device;
means for calculating an expected operating intensity of the security protection software based on the state information; and
means for operating the security protection software based on the calculated expected operating intensity, so as to adjust the amount of system resources occupied by the security protection software.

12. The apparatus according to claim 11, wherein the state information includes:
timing, type, number of times and/or frequency of an operation performed by a user of the user device; and/or
software environment information and/or hardware environment information of the user device.

13. The apparatus according to claim 12, wherein the operation performed by the user is directly obtained from a driver layer, so as to avoid a collision with other software running on the user device.

14. The apparatus according to claim 12, wherein the software environment information and/or hardware environment information includes at least one of:
a size of memory of the user device, a usage condition of the memory of the user device, a speed of a processor of the user device, a usage condition of the processor of the user device, information of processes currently running on the user device, a current network connection condition of the user device, a current bandwidth usage condition of the user device, and a usage condition of an input device of the user device.

15. The apparatus according to claim 14, further comprises:
means for reducing an amount of various network request data associated with the security protection software if the network connection condition belongs to per-flow accounting.

16. The apparatus according to claim 11, wherein the state information includes state information at present and/or in a past period of time.

17. The apparatus according to claim 11, wherein the operating intensity includes an operating frequency of a thread of the security protection software.

18. The apparatus according to claim 11, wherein the operating intensity does not have a limited number of fixed levels assigned thereto, such that the operating intensity is adjusted without being limited to the fixed levels.

19. The apparatus according to claim 11, wherein a gradual change policy is used if the operating intensity of the security protection software is to be increased, and a sudden change policy is used if the operating intensity of the security protection software is to be decreased.

20. The apparatus according to claim 15, wherein
the operation performed by the user is directly obtained from a driver layer, so as to avoid a collision with other software running on the user device;
the state information includes state information at present and/or in a past period of time;
the operating intensity includes an operating frequency of a thread of the security protection software;
the operating intensity does not have a limited number of fixed levels assigned thereto, such that the operating intensity is adjusted without being limited to the fixed levels; and
a gradual change policy is used if the operating intensity of the security protection software is to be increased, and a sudden change policy is used if the operating intensity of the security protection software is to be decreased.
